(19) United States
(12) Patent Application Publication
(10) Pub. No.: US 2025/0276385 A1
(43) Pub. Date: Sep. 4, 2025

(54) CUTTING TOOL HAVING A CUTTING HEAD AND AN ADAPTER HAVING A CLAMPING MECHANISM THEREOF

(71) Applicant: ISCAR, LTD., TEFEN (IL)

(72) Inventor: MARK ASHQAR, FASUTA (IL)

(73) Assignee: ISCAR, LTD., TEFEN (IL)

(21) Appl. No.: 19/013,335

(22) Filed: Jan. 8, 2025

Related U.S. Application Data
(60) Provisional application No. 63/559,414, filed on Feb. 29, 2024.

(51) Int. Cl. B23B 27/16

(52) U.S. Cl. CPC B23B 27/16

(57) ABSTRACT

A cutting tool having an adapter and a cutting head. The adapter has an adapter clamping portion and a clamping mechanism. The clamping mechanism has an actuator, a central wedge and two flanges slidingly engaged to the central wedge. Each of the two flanges has an elongated rear slanted flange portion configured for clamping the cutting head.

### CROSS-REFERENCE TO RELATED APPLICATION

This application claims benefit of, and priority to, U.S. Provisional Patent Application Ser. No. 63/559,414, filed Feb. 29, 2024, the entire contents of which are hereby incorporated by reference.

### FIELD OF THE INVENTION

The subject matter of the present application relates to clamping mechanisms, in general, and in particular to cutting heads releasably secured to an adapter using a clamping mechanism.

### BACKGROUND OF THE INVENTION

In the field of metal cutting, interchangeable cutting heads which are releasably secured to an adapter are known. For example, an interchangeable cutting head releasably secured to an adapter is shown in US2015174666.

Also known are force multiplier mechanisms used in clamping a first part to a second part. Force multiplier mechanisms refer to mechanisms where the clamping means (such as, for example, bearing balls or flanges) are located on opposing sides of an actuator which actuates (i.e. activates) the clamping means, enabling greater forces for clamping. For example, such force multiplier mechanisms can be seen in U.S. Pat. Nos. 4,736,659, 5,261,302, and 11,358,227.

### SUMMARY OF THE INVENTION

The subject matter of this application may be an adapter with an improved force multiplier mechanism. Such an improved force multiplier mechanism may allow for more stable clamping.

In accordance with a first aspect of the subject matter of the present application there is provided an adapter having a central adapter axis Ca defining an outward radial direction Ro extending away from the central adapter axis Ca, opposing forward and rearward adapter directions Fa, Ra and a central plane Pc orthogonal to the central adapter axis Ca, the adapter 20 comprising:
a rear adapter end section;
a forward adapter end section located forward of the rear adapter end section and a peripheral adapter surface connecting the forward adapter end section and the rear adapter end section;
the forward adapter end section including an adapter clamping portion, the adapter clamping portion comprising an adapter clamping receptacle, the adapter clamping receptacle defining:
   a first flange bore opening out to the peripheral adapter surface;
   a second flange bore opening out to the peripheral adapter surface; and
   an actuator bore extending into the adapter clamping receptacle;
      and
a clamping mechanism comprising:
   an actuator defining an actuating axis A having opposite first and second axial directions D1, D2 extending parallel to the actuating axis A, the actuator being aligned with the actuator bore and being at least partially located in the adapter clamping receptacle;
   a central wedge connected to the actuator;
   a first flange slidingly connected to the central wedge and configured to project through the first flange bore; and
   a second flange opposite the first flange about the actuating axis A, the second flange slidingly connected to the central wedge and configured to project through the second flange bore;
   each of the first and second flanges comprising:
      a forward facing flange surface; and
      a rearward facing flange surface, the rearward facing flange surface comprising a rear slanted flange portion, the rear slanted flange portion extending forwardly in the outward radial direction Ro, the rear slanted flange portion elongated in a direction along the central plane Pc.

In accordance with a second aspect of the subject matter of the present application there is provided a cutting head defining a central head axis Ch defining forward and rearward head directions Fh, Rh, the cutting head comprising:
a forward head end section;
a rearward head end section located rearward of the forward head end section and a peripheral head surface connecting the forward head end section and the rearward head end section;
the rearward head end section including a head clamping portion, the head clamping portion comprising a receptacle wall, the receptacle wall including a forward facing head clamping surface and a rearward facing head abutment surface, the head clamping surface extending in a direction away from the central head axis Ch and in the forward head direction Fh, the receptacle wall defining:
   a head clamping receptacle recessed into the head clamping portion; and
   an actuator access bore opening out to the peripheral head surface and to the head clamping receptacle;
the peripheral head surface including an integral cutting element or defining a cutting insert pocket (152) configured to receive a cutting element.

In accordance with a third aspect of the subject matter of the present application there is provided a cutting tool comprising
an adapter; and
the cutting head according to the second aspect.

In accordance with a fourth aspect of the subject matter of the present application there is provided a cutting tool comprising
an adapter according to the first aspect; and
a cutting head attached to the adapter, the cutting head defining a central head axis coinciding with the central adapter axis of the adapter and having forward and rearward head directions extending parallel to the central head axis.

It is understood that the above-said is a summary, and that features described hereinafter may be applicable in any combination to the subject matter of the present application, for example, any of the following features may be applicable to the cutting tool and/or the adapter and/or the cutting head. The rear slanted flange portion may be cone shaped. Each of the first and second flanges may comprise: a wedge connector portion located adjacent to the central wedge, the wedge connector portion connecting the forward and rearward facing flange surfaces, the wedge connector portion of the first flange slants towards the actuating axis A in the first axial direction D1 and the wedge connector portion of the second flange slants towards the actuating axis A in the first axial direction D1. A wedge connector angle wca, defined between the actuating axis A and the wedge connector portion of one of the first and second flanges, may fulfil the following condition: 5°≤wca≤25°. Each of the first and second flanges may comprise, at the wedge connector portion, a flange dovetail formation, the central wedge comprises two wedge dovetail formations engaging with the flange dovetail formations; each of the flange dovetail formations in sliding engagement with one of the two wedge dovetail formations in a direction along the actuating axis A. The actuator may have an active position in which the first and second flanges project radially from the first and second flange bores, respectively, wherein the actuator has an inactive position in which the first and second flanges do not project radially from the first and second flange bores, respectively. Each of the first and second flanges may further comprise: an outer flange surface facing away from the actuating axis A, wherein in the inactive position, the outer flange surface of each of the first and second flanges is level with the peripheral adapter surface adjacent to the respective one of the first and second flange bores. A rear slanted flange angle rsa, defined between the central plane Pc and the rear slanted flange portion, may fulfil the following condition: 3°≤rsa≤20°. The clamping mechanism may further comprise an actuator captive mechanism securing the actuator in the adapter. The rearward facing flange surface may be planar. The first and second flanges may be identical. The central wedge may comprises: a first wedge surface; a second wedge surface located farther in the second axial direction D2 than the first wedge surface; a forward wedge surface connecting the first and second wedge surfaces; a rearward wedge surface located rearwardly of the forward wedge surface and connecting the first and second wedge surfaces; an actuator wedge section extending between the first and second wedge surfaces and engaged to the actuator; a first flange connector portion slidingly connected to the first flange, the first flange connector portion extending between the first and second wedge surfaces; and a second flange connector portion slidingly connected to the second flange, the second flange connector portion extending between the first and second wedge surfaces. The first flange connector portion may slant towards the actuating axis A in the first axial direction D1; and the second flange connector portion may slant towards the actuating axis A in the first axial direction D1. A flange connector angle fca, defined between the first and second flange connector portions, may fulfil the following condition: 10°≤fca≤50°. The wedge and flange connector angles wca, fca may fulfil the following condition: fca=2*wca. Each of the first and second flanges may comprise a wedge dovetail formation. The head clamping surface may be elongated in a direction about the central head axis Ch. The head clamping surface may encircle the central head axis Ch. The head clamping surface may be cone shaped. A head clamping angle hca, defined between the head clamping surface and a head plane Ph, the head plane Ph being perpendicular to the central head axis Ch, may fulfil the following condition: 5°≤hca≤22°. The head abutment surface may comprise: two rear abutting portions and two relief portions located forwardly of the two rear abutting portions, each of the two relief portions being located between the two rear abutting portions.

### BRIEF DESCRIPTION OF THE FIGURES

For a better understanding of the present application and to show how the same may be carried out in practice, reference will now be made to the accompanying drawings, in which:

FIG. 1 is a perspective view of a cutting tool according to an aspect of the present application including an adapter and a cutting head;

FIG. 2 is an exploded view, with parts separated, of the cutting tool shown in FIG. 1;

FIG. 3 is a perspective view of the adapter shown in FIG. 1;

FIG. 4 is a front view of the adapter shown in FIG. 3;

FIG. 5 is a rear view of the adapter shown in FIG. 3;

FIG. 6 is a flange-side view of the adapter shown in FIG. 3;

FIG. 7 is a cross-sectional view taken along line A-A of the adapter shown in FIG. 6;

FIG. 8 is a cross-sectional view taken along line B-B of the adapter shown in FIG. 6;

FIG. 9 is an actuator side view of the adapter shown in FIG. 3;

FIG. 10 is a cross-sectional view taken along line C-C of the adapter shown in FIG. 9;

FIG. 11 is a perspective view of a clamping mechanism shown in FIG. 2;

FIG. 12 is an exploded view, with parts separated, of the clamping mechanism shown in FIG. 11;

FIG. 13a is a perspective view of a central wedge shown in FIG. 11;

FIG. 13b is a first side view of the central wedge shown in FIG. 13a;

FIG. 13c is an axial view of the central wedge shown in FIG. 13a;

FIG. 13d is a second side view of the central wedge shown in FIG. 13a;

FIG. 13e is a cross-sectional view taken along line D-D of the central wedge shown in FIG. 13d;

FIG. 14a is a perspective view of one of a first and second flanges shown in FIG. 11;

FIG. 14b is an axial view of the flange shown in FIG. 14a;

FIG. 14c is an outer radial view of the flange shown in FIG. 14a;

FIG. 14d is a wedge connector view of the flange shown in FIG. 14a;

FIG. 14e is a first side view of the flange shown in FIG. 14a;

FIG. 14f is a second side view of the flange shown in FIG. 14a;

FIG. 15 is an actuator access view of a cutting head without insert pockets yet formed thereon and according to an aspect of the present invention;

FIG. 16 is a cross-sectional view taken along line E-E of the cutting head shown in FIG. 15;

FIG. 17 is a rear view of the cutting head shown in FIG. 15;

FIG. 18 is an actuator side view of the cutting tool shown in FIG. 1;

FIG. 19 is a flange side view of the cutting tool shown in FIG. 1;

FIG. 20 is an active position cross-sectional view taken along line F-F of the cutting tool shown in FIG. 19;

FIG. 21 is an inactive position cross-sectional view taken along line F-F of the cutting tool shown in FIG. 19;

FIG. 22 is a perspective view of a cutting tool without insert pockets yet formed on the cutting head, according to an aspect of the present invention; and

FIG. 23 is an exploded view, with parts separated of the cutting tool shown in FIG. 22.

It will be appreciated that for simplicity and clarity of illustration, elements shown in the figures have not necessarily been drawn to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the subject matter of the present application will be described. For purposes of explanation, specific configurations and details are set forth in sufficient detail to provide a thorough understanding of the subject matter of the present application. However, it will also be apparent to one skilled in the art that the subject matter of the present application can be practiced without the specific configurations and details presented herein.

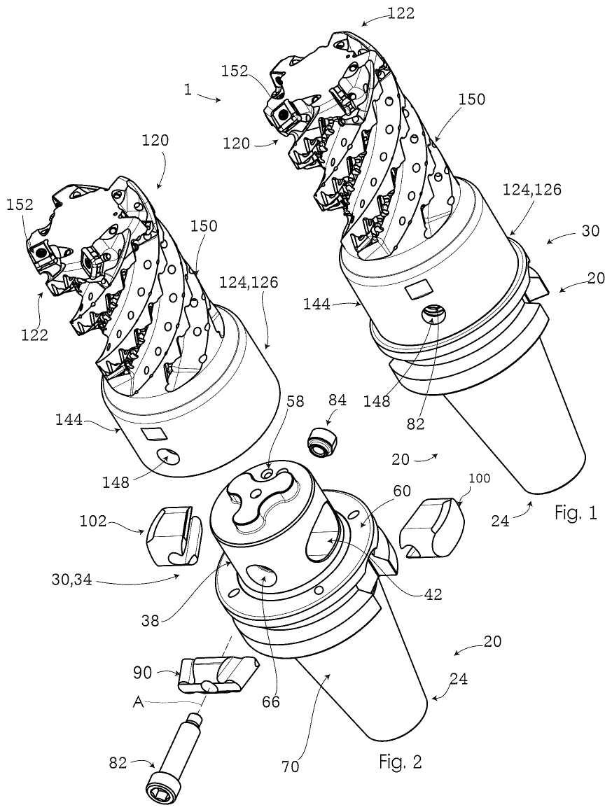

Attention is first drawn to FIGS. 1 and 2, showing a cutting tool 1 having a cutting head 120 releasably attached to an adapter 20 via a clamping mechanism 80. The clamping mechanism 80 may synonymously be referred to as a clamping insert, a clamping arrangement, or an expandable wedge herein. The cutting head 120 can accommodate cutting elements (not shown). For example, such cutting elements may be integrally formed cutting teeth or, more typically, interchangeable cutting inserts. Such cutting elements may be made from hard metals, such as cemented carbide. The cutting elements may be made of harder material than the cutting head 120.

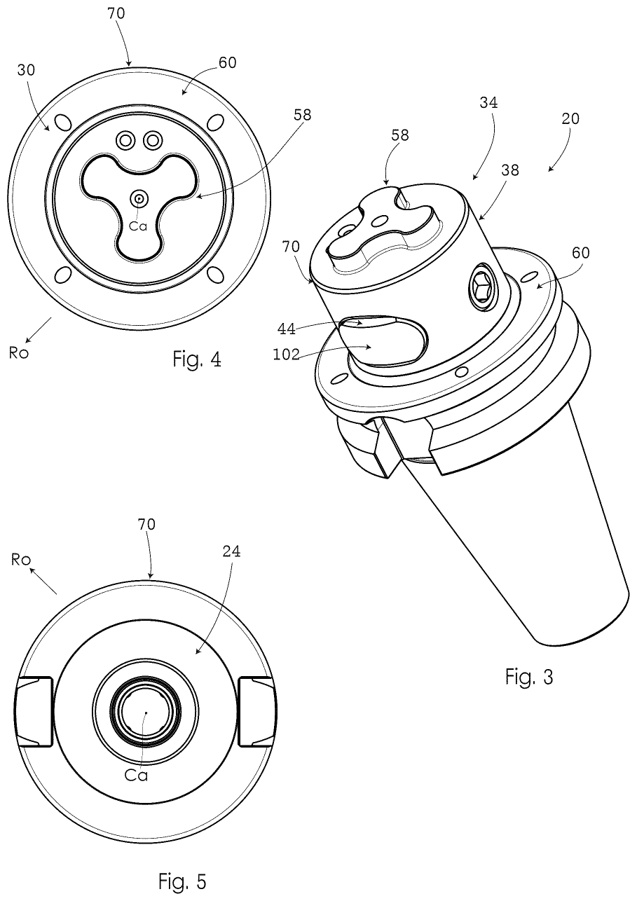

Drawing attention to FIGS. 3 to 10, the adapter 20 has a central adapter axis Ca. The central adapter axis Ca defines an outward radial direction Ro, a forward adapter direction Fa and a rearward adapter direction Ra opposite to the forward adapter direction Fa. The outward radial direction Ro is perpendicular to the central adapter axis Ca, from the central adapter axis Ca outwards. The forward and rearward adapter directions Fa, Ra may be parallel to the central adapter axis Ca.

The adapter 20 includes a rear adapter end section 24, a forward adapter end section 30, a peripheral adapter surface 70 and a clamping mechanism 80. The forward adapter end section 30 is located forward of the rear adapter end section 24. The peripheral adapter surface 70 connects the rear and forward adapter end sections 24, 30.

The forward adapter end section 30 includes an adapter clamping portion 34. The adapter clamping portion 34 includes an adapter clamping receptacle 38 and defines a first flange bore 42, a second flange bore 44, and an actuator bore 66. As best seen in FIG. 10, the adapter clamping receptacle 38 is at least partially hollow. The adapter clamping receptacle 38 defines a hollow portion 40. The hollow portion 40 may allow at least part of the clamping mechanism 80 to be placed therein. In some embodiments, the adapter clamping receptacle 38 is centered about the central adapter axis Ca. In some embodiments, the adapter clamping portion 34 further includes an adapter torque transfer mechanism 58. Such an adapter torque transfer mechanism 58 may be advantageous, e.g., for rotary cutting tools.

The adapter clamping portion 34 further includes an adapter abutment surface 60. The adapter abutment surface 60 faces in the forward adapter direction Fa. The adapter abutment surface 60 encircles (i.e. surrounds) the central adapter axis Ca. In some embodiments, the adapter abutment surface 60 encircles the adapter clamping receptacle 38. In such embodiments, the adapter abutment surface 60 may delimit the adapter clamping portion 34 in the rearward adapter direction Ra. Having the adapter abutment surface 60 encircle the adapter clamping receptacle 38 may allow for a more stable clamping between the adapter 20 and the cutting head 120.

Each of the first and second flange bores 42, 44 are formed in the adapter clamping receptacle 38. Each of the first and second flange bores 42, 44 open out to the peripheral adapter surface 70. Further, each of the first and second flange bores 42, 44 open out to the hollow portion 40 of the adapter clamping receptacle 38. In some embodiments the first and second flange bores 42, 44 are located on opposite sides of the central adapter axis Ca. Specifically, the first and second flange bores 42, 44 are opposite one another relative to the central adapter axis Ca.

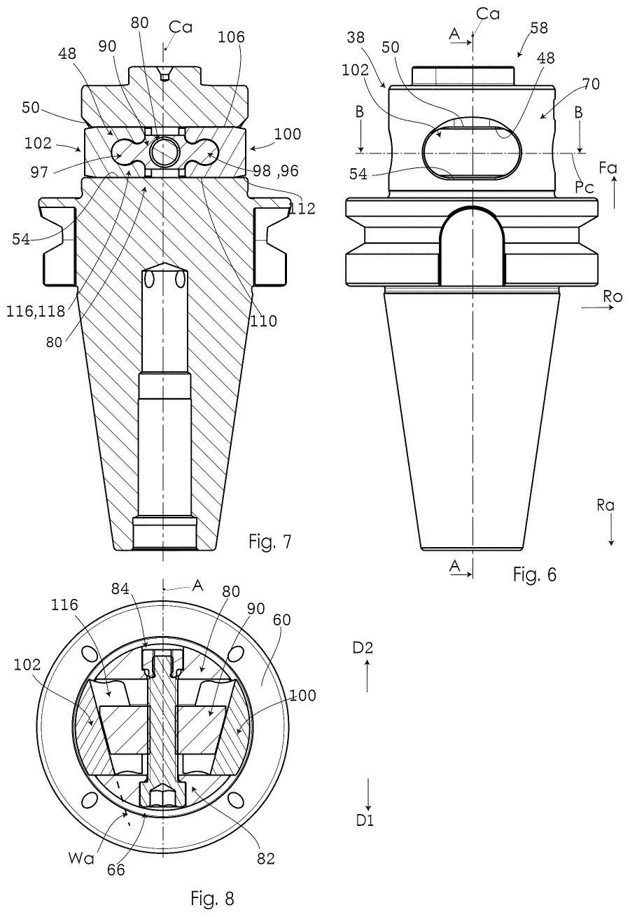

In some embodiments, each of the first and second flange bores 42, 44 is at least partially defined by a forward bore surface 48 and/or a rearward bore surface 54 (see FIG. 6). The forward bore surface 48 faces in the rearward adapter direction Ra. The rearward bore surface 54 is located rearwardly of, and faces in the direction of, the forward bore surface 48. Each of the forward and rearward bore surfaces 48, 54 may be orthogonal to the central adapter axis A. The forward and rearward bore surfaces 48, 54 may oppose one another.

In some embodiments, the forward bore surface 48 includes a chamfered bore portion 50. The chamfered bore portion 50 is slanted in the forward adapter direction Fa and in the outward radial direction Ro. This chamfered bore portion 50 may ensure that the clamping mechanism 80 (and specifically a first flange 100 and a second flange 102 as discussed below) does not deform the forward bore surface 48 when securing the cutting head 120 to the adapter 20.

The actuator bore 66 extends into the adapter clamping receptacle 38. Specifically, the actuator bore 66 opens out to at least one of the hollow portion 40 or the peripheral adapter surface 70. The actuator bore 66 may open out to both the hollow portion 40 and the peripheral adapter surface 70, allowing an actuator 82, as will be discussed below, to pass therethrough. In some embodiments, the first and second flange bores 42, 44 are located on opposite sides of the central adapter axis Ca and on opposite sides of the actuator bore 66.

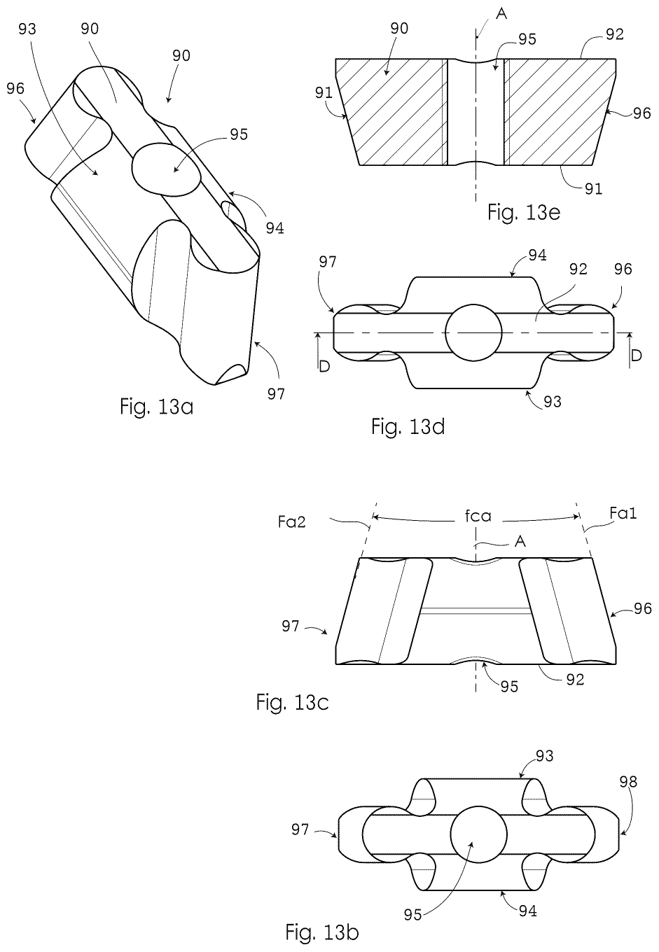

As best seen in FIGS. 11 to 14f, the clamping mechanism 80 includes an actuator 82, a central wedge 90, a first flange 100, and a second flange 102. The actuator 82 defines an actuating axis A. The actuating axis A extends in a first axial direction D1 and an opposite second axial direction D2. The actuator 82 is aligned with the actuator bore 66 and is at least partially located in the adapter clamping receptacle 38. Specifically, the actuator bore 66 may open out to the hollow portion 40 of the adapter clamping receptacle 38.

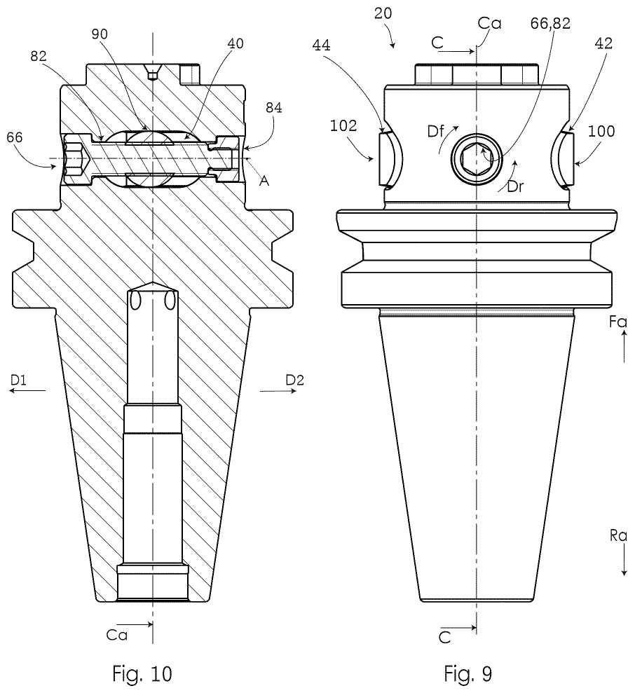

A key (not shown) actuates the actuator 82. The actuator 82 may be rotated about the actuating axis A in a first or fastening direction Df and an opposite second or releasing direction Dr (see FIG. 9). In some embodiments the actuator 82 may be, as seen in the attached figures, a screw. In some embodiments, the key causes the actuator 82 to rotate in the fastening and releasing directions Df, Dr. Alternatively, the key 100 may cause the actuator 82 to move in different directions, such as the first or second axial directions D1, D2, e.g., by exerting forces axially along the actuating axis A or by threads of the actuator 82 engaging surfaces disposed about the actuating axis A upon rotation of the actuator 82.

In some embodiments, the actuating axis A is perpendicular to the central adapter axis Ca. Alternatively, the actuating axis A may be, for example, parallel to the central adapter axis Ca.

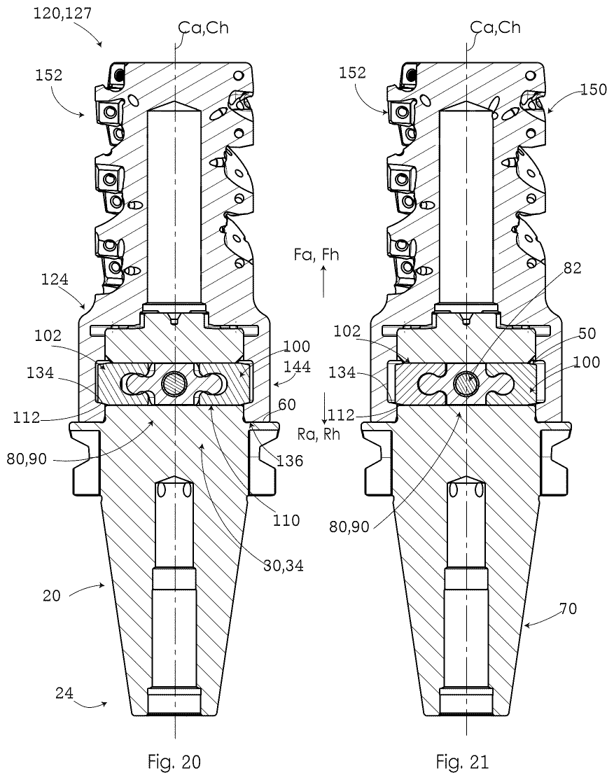

As shown in FIGS. 20 and 21, the adapter 20 has an active position (seen in FIG. 20) and an inactive position (seen in FIG. 21). In the active position, the actuator 82 is actuated so that the first and second flanges 100, 102 project radially or extend from, respectively, the first and second flange bores 42, 44. In the inactive position, the actuator 82 is actuated so that the first and second flanges 100, 102 do not project radially or are retracted from, respectively, the first and second flange bores 42, 44. That is to say, in the active position the first and second flanges 100, 102 extend farther in the outward radial direction Ro relative to the first and second flange bores 42, 44. Similarly, in the inactive position the first and second flange bores 42, 44 are level with, or extend farther than, the first and second flanges 100, 102 in the outward radial direction Ro. Having the first and second flanges 100, 102 retracted into the adapter 20 when the actuator 82 is in the inactive position may allow, for example, for a thicker cutting head 120, instead of, for example, creating grooves to accommodate partially protruding flanges therein. This may positively affect the stability of the cutting tool 1.

In some embodiments, each of the first and second flanges 100, 102 further include an outer flange surface 114. The outer flange surface 114 faces away from the actuating axis A. The outer flange surface 114 may connect forward and rearward facing flange surfaces 106, 110 as discussed below. In the inactive position (defined herein above as the inactive position of the adapter 20), the outer flange surface 114 of each of the first and second flanges 100, 102 is level with the peripheral adapter surface 70 adjacent to the respective one of the first and second flange bores 42, 44.

The first and second flanges 100, 102 are located opposite to one another about the actuating axis A. That is to say, as seen in FIG. 8, the first flange 100 is located on one side of the actuating axis A, and the second flange 102 is located on the other side of the actuating axis A. In some embodiments, the actuator 82, the first flange 100 and the second flange 102 are level with one another along the central adapter axis Ca. In other embodiments, the first and second flanges 100, 102 may be level with one another along the central adapter axis Ca with the actuator 82 being located either rearwardly or forwardly of the first and second flanges 100, 102.

The central wedge 90 is connected to the actuator 82. Such a connection ensures that the central wedge 90 is moveable by the actuator 82. The connection may be, for example, a threaded connection with the central wedge 90 and the actuator 82 each having threads therein. When the key actuates the actuator 82, the central wedge 90 is moved. Specifically, the central wedge 90 may be moved axially along the actuating axis A. The first and second flanges 100, 102 are in sliding connection with the central wedge 90. That is to say, the first and second flanges 100, 102 are secured to the central wedge 90 such that movement between each of the first and second flanges 100, 102 and the central wedge 90 is allowed in some directions but is not allowed or restricted in other directions. As best shown in FIGS. 8, 20, and 21, the first and second flanges 100, 102 are moveable in a direction perpendicular to the actuating axis A, but are not moveable along the actuating axis A and the central adapter axis Ca.

The first and second flanges 100, 102 are configured to project through the first and second flange bores 42, 44, respectively. That is to say, the first flange 100 is configured to project through the first flange bore 42 and the second flange 102 is configured to project through the second flange bore 44. The first and second flanges 100, 102 are at least partially located within the first and second flange bores 42, 44, respectively.

The above-described clamping mechanism 80 is a so-called “force multiplier”. Such a mechanism is capable of providing greater clamping forces than the force provided by the actuator 82 alone. This is due, in part, to the first and second flanges 100, 102 moving in a direction transverse (i.e. not parallel) to the actuating axis A. There are additional factors facilitating such clamping forces, for example the angle of surfaces participating in the clamping of the adapter 20 and the cutting head 120, as discussed below. The clamping mechanism 80 described herein may be desirable for rotary cutting tools (for example milling tools) which experience complex and varying cutting forces during machining operations. The adapter 20 and its clamping mechanism 80 may provide improved stability and great clamping forces than a clamping mechanism without first and second flanges and/or without the angle of surfaces as discussed below.

When the central wedge 90 is moved by the actuator 82, the first and second flanges 100, 102 slide along the central wedge 90 while still being located within the first and second flange bores 42, 44. The first and second flanges 100, 102 are thus movable relative to the adapter 20, but only in a direction different from the direction in which the central wedge 90 is moved. The movement of the first and second flanges 100, 102 relative to the central wedge 90 may, for example, cause the first and second flanges 100, 102 to either protrude out, or retract inwardly, of the peripheral adapter surface 70.

In the active position, when the key actuates the actuator 82, the central wedge 90 is moved, causing the first and second flanges 100, 102 to move slidingly relative to the central wedge 90 and project outwards from their respective one of the first or second flange bores 42, 44. Likewise, in the inactive position, when the key actuates the actuator 82, the central wedge 90 is moved, causing the first and second flanges 100, 102 to move slidingly relative to the central wedge 90 and retract inwardly within their respective one of the first or second flange bores 42, 44.

In some embodiments, in the active position, the actuator 82 is actuated by rotation in the fastening direction Df. Then the central wedge 90 is moved in the first axial direction D1. Likewise, in the inactive position, the actuator 82 is rotated in the releasing direction Dr. Then the central wedge is moved in the second axial direction D2 (see FIGS. 8 and 9).

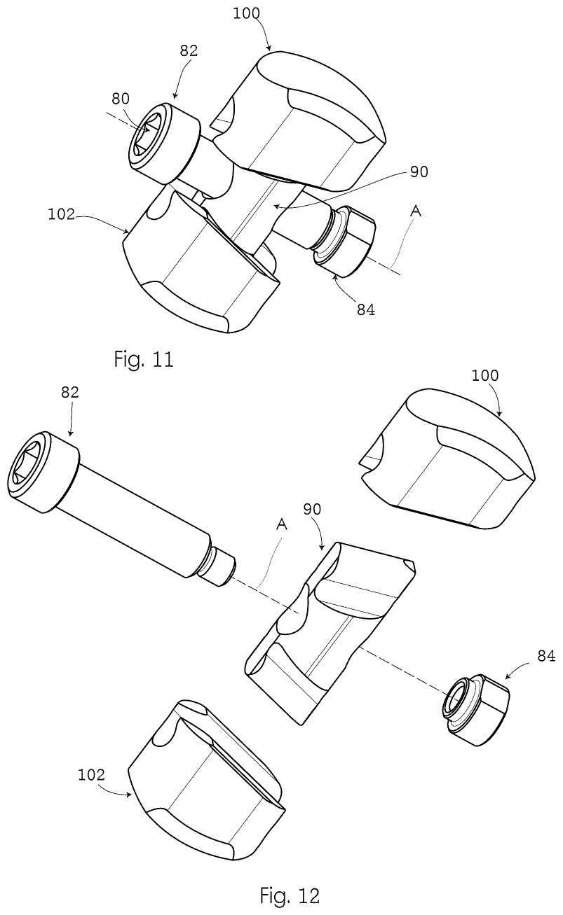

In some embodiments, where the actuator 82 is actuated through rotating about the actuating axis A, the clamping mechanism 80 may further include an actuator captive mechanism 84 (see FIGS. 11 and 12). The actuator captive mechanism 84 secures the actuator 82 in the adapter 20, ensuring that while the actuator 82 is movable in order to facilitate a clamping engagement between the adapter 20 and the cutting head 120, the actuator 82 remains within the adapter 20. In the embodiments shown in the Figures, the actuator 82 is a screw and the actuator captive mechanism 84 is a nut engaging the screw to ensure it does not detach from the adapter 20. The actuator captive mechanism 84 is not confined to a nut or the like and may, for example, include a pin (not shown) engaging a recessed portion of a screw, the screw acting as the actuator 82.

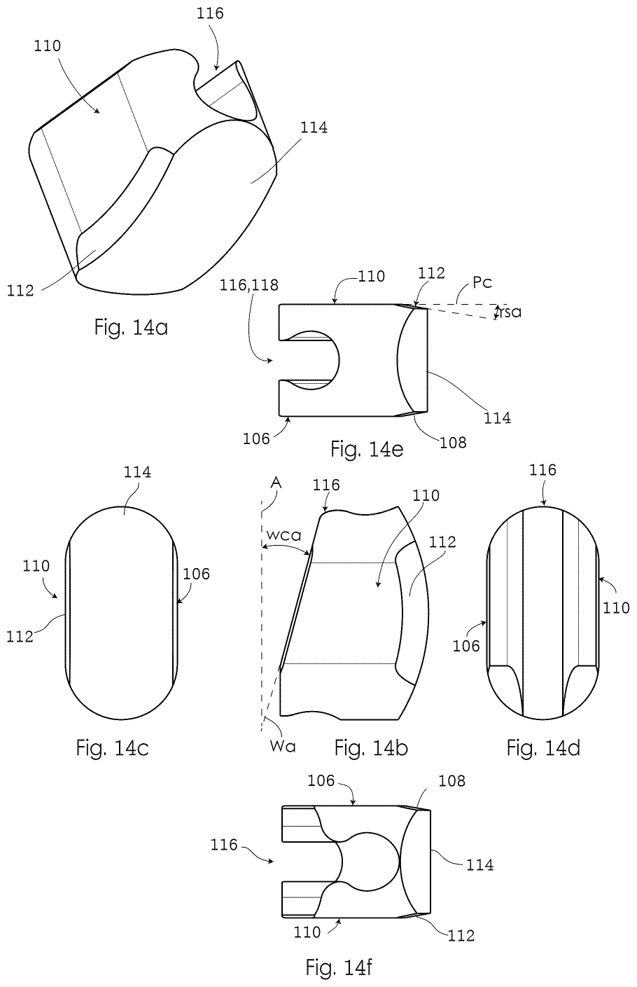

The following description will refer to features shared by both the first and second flanges 100, 102 using the same numerals. In embodiments, the first and second flanges 100, 102 correspond to the extent that they are interchangeable. The first and second flanges 100, 102 may be identical to one another. It will be noted that in some embodiments, the first and second flanges 100, 102 are both identical and interchangeable, as shown in FIGS. 14a to 14f. The flange shown embodies either of the first and second flanges 100, 102. In other envisioned embodiments the first and second flanges 100, 102 are not required to be identical with respect to all features thereof.

Each of the first and second flanges 100, 102 includes a forward facing flange surface 106 and a rearward facing flange surface 110. The forward facing flange surface 106 faces in the forward adapter direction Fa. The rearward facing flange surface 110 faces in the rearward adapter direction Ra. The forward facing flange surface 106 may be opposite the rearward facing flange surface 110. The rearward facing flange surface 110 includes a rear slanted flange portion 112. The rear slanted flange portion 112 is a portion of the rearward facing flange surface 110 that extends forward in the outer radial direction Ro. That is to say, the rear slanted flange portion 112 faces in both the rearward adapter direction Ra and in the outward radial direction Ro. In some embodiments, the forward facing flange surface 106 includes an additional slanted flange surface 108 corresponding to the rear slanted flange surface 112. This can facilitate using the first and second flanges 100, 102 interchangeably. Further, in some embodiments, the forward and rearward facing flange surfaces 106, 110 are identical to one another.

A central plane Pc is defined as orthogonal to the central adapter axis Ca. The rear slanted flange portion 112 is elongated in a direction along the central plane Pc. In some embodiments, the rear slanted flange portion 112 is specifically elongated in a direction circumferential to the adapter. Differently worded, the rear slanted flange portion 112 has a greater extent along a direction perpendicular to the central adapter axis Ca, relative to the extent of the rear slanted flange portion 112 in other directions. The rear slanted flange portion 112 extends about the central adapter axis Ca.

The rear slanted flange portion 112 being elongated in a direction along the central plane Pc allows two points of contact between the rear slanted flange portion 112 and the cutting head 120. Having a two-point contact between the cutting head 120 and each of the first and second flanges 100, 102 ensures increased stability in the clamping between the adapter 20 and the cutting head 120. Additionally, the direction of elongation of the rear slanted flange portion 112 may further ensures that the clamping forces arising from the abutment of the cutting head 120 and each of the first and second flanges 100, 102 is directed mainly in the rearward adapter direction Ra which may increase the stability of the connection between the adapter 20 and the cutting head 120.

In some embodiments, the rearward facing flange surface 110 is planar. Further, the rearward facing flange surface 110 may be parallel to the central plane Pc. When the rear slanted flange portion 112 clamps the cutting head 120, the forward facing flange surface 106 and the rearward facing flange surface 110 abut against the forward and rearward bore surfaces 48, 54, respectively. Having the rearward facing flange surface 110 planar may ensure a more stable abutment between the first and second flanges 100, 102 and the forward and rearward bore surfaces 48, 54. Note that the rearward facing flange surface 110 may be split, for example by a recessed portion. As explained above, such a planar surface may improve stability.

In some embodiments, the rear slanted flange portion 112 is cone shaped. As seen in the figures, the rear slanted flange portion 112 is slanted relative to the central adapter axis Ca, In embodiments where the rear slanted flange portion 112 is annular, the resulting geometric shape may be conical. Alternatively, the rear slanted flange portion 112 may be, for example, flat, chamfered, or recessed. The shape of the rear slanted flange portion 112 needs to conform to the shape of the relative feature of the cutting head 120 against which it abuts, which will be discussed below. A cone-shape may be desirable as it is a relatively simple shape to machine, and may result in high accuracy. This advantage may be relevant to both the first and second flanges 100, 102 as well as the cutting head 120. Additionally, such a shape may further assure of two-point contact between the rear slanted flange portion 112 and the cutting head 120.

In some embodiments, a rear slanted flange angle rsa is defined between the central plane Pc and the rear slanted flange portion 112. The rear slanted flange angle rsa may fulfil the following condition: 3°≤rsa≤20°. The rear slanted flange angle rsa may further fulfil the following condition: 5°≤rsa≤15°. Specifically, the rear slanted flange angle rsa may fulfil the following condition: 8°≤rsa≤12°.

The above-mentioned angle ranges for the rear slanted flange angle rsa may balance the direction of the clamping forces and the extent to which the first and second flanges 100, 102 project. This is detailed as follows:
For higher values of the rear slanted flange angle rsa, the clamping forces between the first and second flanges 100, 102 and the cutting head 120 may be, for example, directed more along the outward radial direction Ro relative to lower values of the rear slanted flange angle rsa. Thus, clamping forces between the adapter and the cutting head 120 are lower for higher values of rear slanted flange angle rsa, relative to lower values of the rear slanted flange angle rsa.
For lower values of the rear slanted flange angle rsa, the first and second flanges 100, 102 may, for example, meet greater resistance when moved by the central wedge 90. This may limit the extent to which each of the first and second flanges 100, 102 protrude outwards of the first and second flange bores 42, 44, which may negatively affect the clamping between the adapter 20 and the cutting head 120.

Each of the first and second flanges 100, 102 may further include a wedge connector portion 116. The wedge connector portion 116 is located adjacent to the central wedge 90. The wedge connector portion 116 connects the forward and rearward facing flange surfaces 106, 110. As explained above, the wedge connector portion 116 is configured for sliding movement relative to the central wedge 90 while securing the flange to the central wedge 90. Such a configuration can be achieved, for example, through a dovetail connection. As shown in the figures, the wedge connector portion 116 may be a female dovetail part. Alternatively, the wedge connector portion 116 may be a male dovetail part, or any configuration which allows relative movement between the central wedge 90 and each of the first and second flanges 100, 102.

In embodiments such as described above, where each of the first and second flanges 100, 102 includes a wedge connector portion 116 shaped for a dovetail connection, each of the first and second flanges 100, 102 may comprise a flange dovetail formation 118. The flange dovetail formation 118 is located at the wedge connector portion 116. The flange dovetail formation 118 may be either female or male. Similarly, the central wedge 90 may include two wedge dovetail formations 98.

It will be noted that the clamping mechanism 80 may include more flanges than the first and second flanges 100, 102. That is to say, the clamping mechanism 80 may include a third flange (not shown), as well as a fourth flange (not shown) and so on. The minimum amount of flanges desired is two, as two flanges can allow for stable fastening. In some embodiments, two flanges may be advantageous in view of facilitated manufacturing, less stringent tolerance requirements and less complex and/or smaller parts.

Similarly, the central wedge 90 may then include a number of wedge dovetail formations 98 according to the desired number of flanges. Further, the adapter 20 may include a number of flange bores corresponding to the desired number of flanges. For example, in some embodiments, in a clamping mechanism, a central wedge may comprise three or four wedge dovetail formations, and three or four flanges respectively. An adapter according to this embodiment may comprise three or four flange bores respectively. Additionally, there may be a second central wedge (not shown) additional to the central wedge 90, with the overall number of wedge dovetail formations 98 of all the central wedges being equal to the desired number of flanges.

Each wedge dovetail formations 98 is in sliding engagement with the flange dovetail formation 118 of any of the first and second flanges 100, 102 in a direction along the actuating axis A. It will be noted that the direction of the aforementioned sliding engagement is not necessarily parallel to the actuating axis A.

In some embodiments, the first and second flanges 100, 102 converge towards one another in the first axial direction D1 (see FIG. 8). Differently put, the wedge connector portion 116 of each of the first and second flanges 100, 102 may slant toward the actuating axis A in the first axial direction D1. That is to say, the wedge connector portion 116 of the first flange 100 may slant towards the actuating axis A in the first axial direction D1 and the wedge connector portion 116 of the second flange 102 may slant towards the actuating axis A in the first axial direction D1. Having the first and second flanges 100, 102, and more specifically the wedge connector portion 116 of each of the first and second flanges 100, 102 slanted towards the actuating axis A, facilitates movement of the first and second flanges 100, 102 in a direction different from the direction in which the central wedge 90 is movable. The direction about which each of the first and second flanges 100, 102 are movable may be, for example, parallel to the outward radial direction Ro.

In the embodiments shown in the figures, the central wedge 90 is movable along the actuating axis A, and each of the first and second flanges 100, 102 is movable in a direction perpendicular thereto. Specifically, the first and second flanges 100, 102 may be movable in a direction perpendicular to both the actuating axis A and to the central adapter axis Ca.

In some embodiments, a wedge connector angle wca (shown in FIG. 14b) is defined between the actuating axis A and the wedge connector portion 116 of one of the first and second flanges 100, 102. Differently put, the wedge connector angle wca is defined as the angle between the actuating axis A and the wedge connector portion 116 from a top view (said top view of the wedge connector portion 116 is best shown in FIGS. 8 and 14b). Specifically, the wedge connector portion 116 may define a wedge connector axis Wa, and the wedge connector angle wca may be defined between the actuating axis A and the wedge connector axis Wa. The wedge connector angle wca may be further defined from an axial view of one of the first and second flanges 100, 102 (see FIG. 14b).

The wedge connector angle wca fulfils the following condition: 5°≤wca≤250. In some embodiments, the wedge connector angle wca fulfils the following condition: 10°≤wca≤20°. The wedge connector angle wca may further fulfil the following condition: 12°≤wca≤18°. The wedge connector angle wca influences, for example, the rate at which the first and second flanges 100, 102 are displaced upon actuation of the actuator 82. The above angle ranges may be desirable in consideration of the influences of the wedge connector angle wca.

In some embodiments, the central wedge 90 may include a first wedge surface 91, a second wedge surface 92, a forward wedge surface 93, a rearward wedge surface 94, an actuator wedge section 95, a first flange connector portion 96 and a second flange connector portion 97. The first wedge surface 91 faces in the first axial direction D1. The second wedge surface 92 is located farther in the second axial direction D2 than the first wedge surface 91. The second wedge surface 92 further faces in the second axial direction D2.

The forward wedge surface 93 connects the first and second wedge surfaces 91, 92. The forward wedge surface 93 faces in the forward adapter direction Fa. The rearward wedge surface 94 is located rearwardly of the forward wedge surface 93 and connects the first and second wedge surfaces 91, 92. The rearward wedge surface 94 faces in the rearward adapter direction Ra. The actuator wedge section 95 extends between the first and second wedge surfaces 91, 92 and engages the actuator 82. In some embodiments, the actuator wedge section 95 may be recessed into one of the forward and rearward wedge surfaces 93, 94. Upon actuation of the actuator 82, the actuator wedge section 95 which is engaged to the actuator 82 may then transfer the actuation into a movement of the central wedge 90.

The first flange connector portion 96 is slidingly connected to the first flange 100. The first flange connector portion 96 extends between the first and second wedge surfaces 91, 92. The first flange connector portion 96 may connect the forward and rearward wedge surfaces 93, 94. As mentioned above, the central wedge 90 may include two (or more) wedge dovetail formations 98. At least one of the aforementioned wedge dovetail formations 98 is located at the first flange connector portion 96.

The second flange connector portion 97 is slidingly connected to the second flange 102. The second flange connector portion 97 extends between the first and second wedge surfaces 91, 92. The second flange connector portion 97 may connect the forward and rearward wedge surfaces 93, 94. As mentioned above, the central wedge 90 may include two (or more) wedge dovetail formations 98. At least one of the aforementioned wedge dovetail formations 98 is located at the second flange connector portion 97.

In some embodiments, the first and second flange connector portions 96, 97 slant towards the actuating axis A in the first axial direction D1. That is to say, a portion of each of the first and second flange connector portions 96, 97 that is located adjacent to the first wedge surface 91, is located closer to the actuating axis A relative to a portion of each of the first and second flange connector portions 96, 97 that is located adjacent to the second wedge surface 92. Such a slant may facilitate movement of the first and second flanges 100, 102, as mentioned above, in a direction perpendicular to the central adapter axis A. The dovetail wedge formation 98 of each of the first and second flanges 100, 102 may be located at, respectively, the first and second flange connector portions 96, 97.

In some embodiments a flange connector angle fca is defined between the first and second flange connector portions 96, 97. Specifically, the first flange connector portion 96 may define a first flange connector axis Fa1 and the second flange connector portion 97 may define a second flange connector axis Fa2. The flange connector angle fca may be defined between the first and second flange connector axes Fa1, Fa2. The flange connector angle fca may fulfil the following condition: 10°≤fca≤50°. The flange connector angle fca may further fulfil the following condition: 20°≤fca≤40°. Additionally, the flange connector angle fca may fulfil the following condition: 25°≤fca≤35°. The flange connector angle fca may influence, for example, the rate at which the first and second flanges 100, 102 are displaced upon actuation of the actuator 82. The above angle ranges may be desirable.

In some embodiments, the wedge and flange connector angles wca, fca may fulfil the following condition: fca=2*wca. The flange connector angle fea is measured between the first and second flange connector portions 96, 97 while the wedge connector angle wca is measured between the actuating axis A and the wedge connector portion 116 of one of the first and second flanges 100, 102.

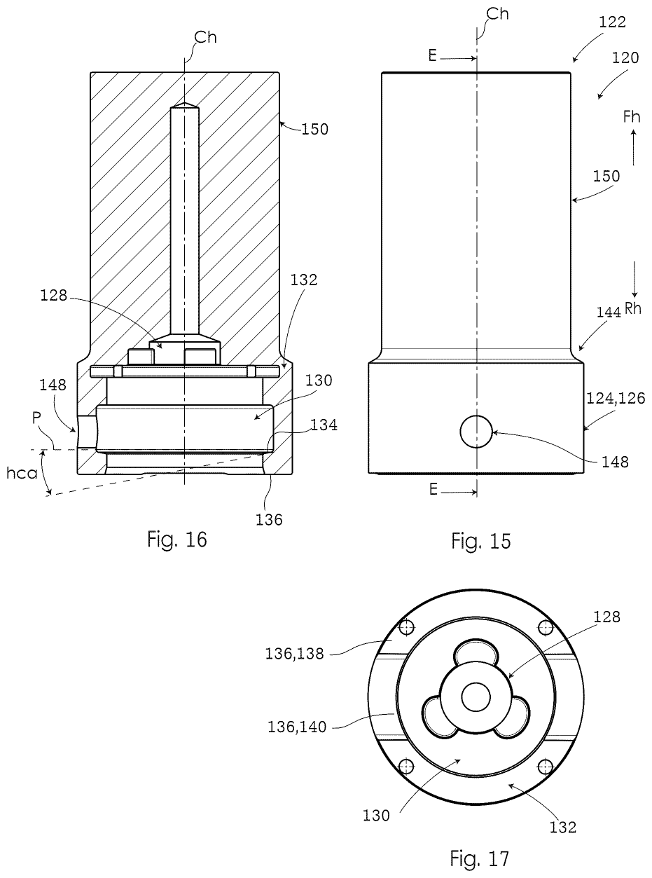

Further reference is now made to FIGS. 15 to 21, a cutting head 120 is shown. The cutting head 120 defines a central head axis Ch and includes a forward head end section 122, a rearward head end section 124 and a peripheral head surface 150. The central head axis Ch defines a forward head direction Fh and a rearward head direction Rh opposite to the forward head direction Fh. The rearward head end section 124 is located farther in the rearward head direction Rh (i.e. rearwardly) of the forward head end section 122. The rearward head end section 124 includes a head clamping portion 126. The peripheral head surface 150 connects the forward head end section 122 and the rearward head end section 124.

The head clamping portion 126 includes a receptacle wall 132 that defines a head clamping receptacle 130 and an actuator access bore 148. The head clamping receptacle 130 is recessed into the head clamping portion 126. The receptacle wall 132 circumferentially bounds the head clamping receptacle 130, with the head clamping receptacle 130 opening out to the cutting head 120. The actuator access bore 148 opens out to the cutting head 120, and more specifically to the peripheral head surface 150, and to the head clamping receptacle 130. In some embodiments, the actuator access bore 148 may open out to the head clamping portion 126, as shown in the figures. Alternatively, the actuator access bore 148 may, for example, open out to the forward head end section 122. The actuator access bore 148 ensures that a key as discussed above can actuate the actuator 82. In some embodiments, the head clamping portion 126 may include a head torque transfer mechanism 128. Such a head torque transfer mechanism 128 may be advantageous for cutting tools, and specifically for rotary cutting tools.

The receptacle wall 132 includes a forward facing head clamping surface 134 and a rearward facing head abutment surface 136. The head clamping surface 134 faces in the forward head direction Fh. The head clamping surface 134 extends away from the central head axis Ch and towards the peripheral head surface 150. Differently put, the head clamping surface 134 is slanted in a direction towards the central holder axis Ch and towards the rearward holder direction Rh. In some embodiments, the head clamping surface 134 is elongated in a direction about the central head axis Ch (i.e. along the central plane Pc or a head plane Pc, as discussed below). The head clamping surface 134 may encircle the central head axis Ch. The head abutment surface 136 faces in the rearward head direction Rh. The head abutment surface 136 may encircle the central head axis Ch.

In some embodiments, the head clamping surface 134 is cone-shaped (i.e., forms concentric circles, with the diameter of such circles decreasing along the rearward holder direction Rh). Such a shape may be able to be produced easily and cheaply, while also providing good precision for abutment.

In some embodiments, the head abutment surface 136 delimits the cutting head 120 in the rearward head direction Rh and encircles the head clamping receptacle 130. Having the head abutment surface 136 located outwardly of the head clamping receptacle 130 may allow for a more stable and/or robust clamping between the adapter 20 and the cutting head 120.

In some embodiments, a head clamping angle hca is defined between the head clamping surface 134 and a head plane Ph. The head plane Ph is perpendicular to the central head axis Ch. The head clamping angle hca is inwardly defined between the head clamping surface 134 and the head plane Ph. The head clamping angle hca may fulfil the following condition: 5°≤hca≤22°. The head clamping angle hca may further fulfil the following condition: 7°≤hca≤17°. Additionally, the head clamping angle hca may fulfil the following condition: 10°≤hca≤14°. The values of the head clamping angle hca are related to the values of the rear slanted flange angle rsa. As mentioned above regarding the rear slanted flange angle rsa, the above angle ranges may be desirable due to considerations such as directionality of clamping forces and the degree to which the first and second flanges 100, 102 may protrude outwards of the first and second flange bores 42, 44, respectively.

It may be desirable in some embodiments that the head clamping angle hea and the rear slanted flange angle rsa fulfil the following condition: rsa≤hca. The head clamping angle hca and the rear slanted flange angle rsa may further fulfil the following condition: rsa<hca≤rsa+5°. Having such a condition may, for example, ensure repeatability in the clamping between the first and second flanges 100, 102 and the head clamping surface 134.

In some embodiments, the head abutment surface 136 includes two rear abutting portions 138 and two relief portions 140. The two relief portions 140 are located farther in the forward holder direction Fh than the two rear abutting portions 138. Each of the two relief portions 140 are located between the two rear abutting portions 138. Further in some embodiments, the two relief portions 140 may be located opposite one another about the central holder axis Ch. Dividing the head abutment portion 136 into two abutting portions and two relieved portions may ensure a better distribution of the clamping forces. To ensure that, each of the two relief portions 140 are located directly rearwardly of one of the first and second flanges 100, 102. Thus, rather than the first and second flanges 100, 102 clamping the cutting head 120 directly against the adapter 20, and focusing the clamping forces in a direction directly rearwardly of them, the clamping forces may be more evenly distributed.

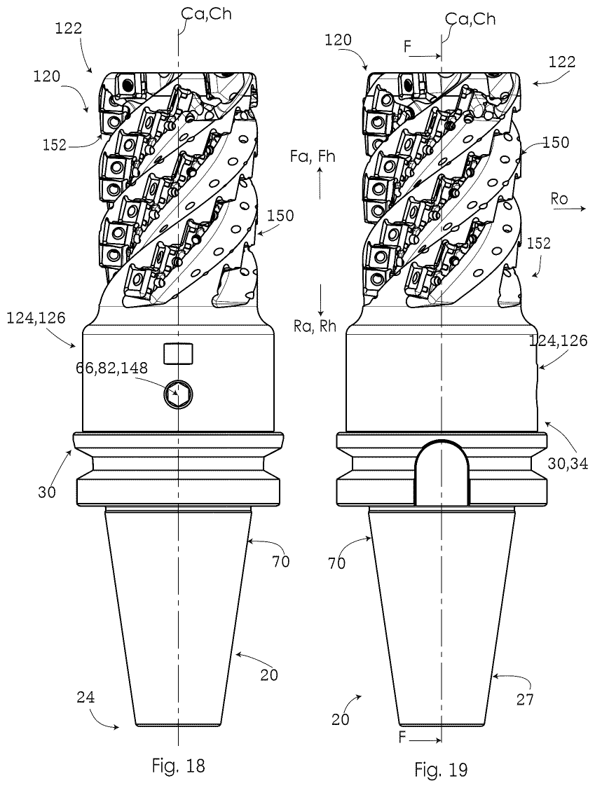

With further reference to FIGS. 1 and 2, as well as FIGS. 18, 19, 20 and 21, as mentioned above, the cutting tool 1 includes the above-mentioned adapter 20 and cutting head 120. The central adapter axis Ca and the central head axis Ch coincide with one another (i.e. overlap and parallel to one another). The forward adapter direction Fa and the forward holder direction Fh align with one another. The rearward adapter direction Ra and the rearward holder direction Rh align with one another. The rear adapter end section 24 may, for example, facilitate clamping of the cutting tool 1 to a turret during machining operations.

When assembling the cutting tool 1 the cutting head 120 is releasably fastened to the adapter 20 via the clamping mechanism 80. The adapter clamping receptacle 38 of the adapter 20 is positioned within the head clamping receptacle 120 (i.e. the receptacle wall 132 encircles the adapter clamping receptacle 38). The adapter clamping portion 34 and the head clamping portion 126 overlap one another. In some embodiments, the adapter torque transfer mechanism 58 engages the head torque transfer mechanism 128.

The actuator bore 66 of the adapter 20 overlaps with the actuator access bore 148 of the cutting head 120. In this manner a key may be inserted through the actuator access bore 148 into engagement with the actuator 82.

When the adapter is in the active position (i.e. has been actuated), as best shown in FIG. 20, the actuator 82 moves the central wedge 90 along the actuating axis A within the hollow portion 40. The movement of the central wedge 90 causes the first and second flange connector portions 96, 97 of the central wedge 90 to abut the wedge connector portion 116 of each of the first and second flanges 100, 102, respectively, and moves the first and second flanges 100, 102 in the outward radial direction Ro. In the active position, the first and second flanges 100, 102 project from the hollow portion 40 and out of the first and second flange bores 42, 44, respectively.

The rear slanted flange surface 112 of each of the first and second flanges 100, 102 clamps against the head clamping surface 134 of the cutting head 120, directing clamping forces against the head clamping surface 134 in both the rearward holder direction Rh and in the outward radial direction Ro. In some embodiments, the clamping forces are directed mainly in the rearward holder direction Rh (interchangeable with the rearward adapter direction Ra). The opposite forces arising from the clamping cause the forward and rearward facing flange surfaces 106, 110 to abut against the forward and rearward bore surfaces 48, 54.

The clamping forces between the head clamping surface 134 and the rear slanted flange surface 112 of each of the first and second flanges 100, 102 bring the adapter abutment surface 60 into abutment against the head abutment surface 136. Due to the direction of the clamping forces, such clamping may be very robust. Similarly, due to the rear slanted flange surface 112 of each of the first and second flanges 100, 102 being elongated as specified, the clamping forces are distributed through at least two points of contact between the rear slanted flange surface 112 of each of the first and second flanges 100, 102 and the head clamping surface 134. Such distribution may, for example, lower the forces working against any specific area of the head clamping surface 134 and the first and second flanges 100, 102. Additionally, such a distribution may, for example, allow for a more stable clamping, due to at least four different points of contact (at least two points of contact between the cutting head 120 and each of the first and second flanges 100, 102) between the adapter 20 and the cutting head 120.

In some embodiments, the relief portion 140 of the cutting head 120 is located directly in the rearward head direction Rh relative to the first and second flange bores 42, 44. Similarly, the relief portion 140 is located directly rearwardly of the first and second flanges 100, 102. Thus, the clamping forces arising from the first and second flanges 100, 102 clamping against the head clamping surface 134 of the cutting head 120 may be more evenly distributed about the head abutment surface 136, and more specifically about the rear abutting portion 138 of the head abutment surface 136. Without the above mentioned relief portion 140 the clamping forces may, for example, be concentrated directly rearwards of the first and second flanges 100, 102, which may adversely affect the stability of the clamping between the adapter 20 and the cutting head 120.

When the adapter 20 is in the inactive position, as best shown in FIG. 21, the actuator 20 moves the central wedge 90 axially along the actuating axis A, in a direction opposite to the direction along which the central wedge 90 is moved when the adapter 20 is in the active position. Said movement of the central wedge 90 causes the first and second flange connector portions 96, 97 of the central wedge 90 to abut the wedge connector portion 116 of each of the first and second flanges 100, 102, respectively, and moves the first and second flanges 100, 102 towards the central adapter axis Ca (i.e. in a direction opposite to the outward radial direction Ro). The first and second flanges 100, 102 are retracted within (i.e. confined to) the adapter 20. Differently put, the first and second flanges 100, 102 do not project out of the first and second flange bores 42, 44. The cutting head 120 is not fastened to the adapter 20 in the inactive position and the cutting head 120 is removable from the adapter 20.

The peripheral head surface 150 includes at least one of a cutting insert pocket 152 and an integral cutting element (not shown). As specified, the cutting head 120 is used in machining operations, specifically metal machining operations. Thus the cutting head 120 must accommodate a cutting element, for example as discussed above, through the at least one insert pocket 152.

In some embodiments, the cutting head 120 may include, at the head clamping portion 126, a thickened head portion 144. The thickened head portion 144 cannot participate in the cutting process of machining operations. Differently put, the thickened head portion 144 is devoid of an integral cutting edge or a cutting insert pocket 152, as discussed above. The peripheral head surface located at the thickened head portion 144 is located farther away from the central head axis Ch relative to the peripheral head surface 152 located at forwardly of the thickened head portion 144. This is done to accommodate the adapter clamping portion 34 within the head clamping receptacle 130. The thickened head portion 144 may be necessary in some cutting heads 120 configured for use with bigger adapters 20. The use of the word “big” herein refers to the dimensions of the adapter 20 relative to the desired dimensions of the cutting head 120.

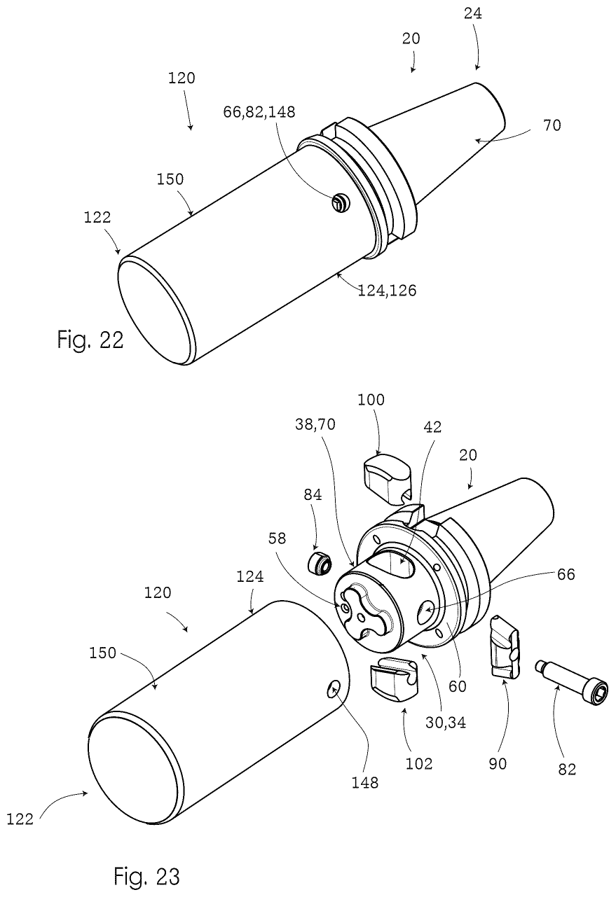

Alternatively, in some embodiments, as shown in FIGS. 22 and 23, cutting head 120′ is shown. Cutting head 120′ can be considered identical to the cutting head 120, with the exception that cutting head 120′ is devoid of a thickened head portion 144. Differently put, the peripheral head surface 150 of the cutting head 120 may coincide with an envelope of a simple geometrical shape, such as, for example as shown in FIGS. 22 and 23, a cylindrical shape. The above specified thickened head portion 144 may not be necessary in some cases, such as where the relative size of the adapter 20 and the cutting head 120 is similar.

While several embodiments of the disclosure have been shown in the drawings, it is not intended that the disclosure be limited thereto, as it is intended that the disclosure be as broad in scope as the art will allow and that the specification be read likewise. Any combination of the above embodiments is also envisioned and is within the scope of the appended claims. Therefore, the above description should not be construed as limiting, but merely as exemplifications of particular embodiments. Those skilled in the art will envision other modifications within the scope of the claims appended hereto.

What is claimed is:

1. An adapter (20) having a central adapter axis (Ca) defining an outward radial direction (Ro) extending away from the central adapter axis (Ca), opposing forward and rearward adapter directions (Fa, Ra) extending parallel to the central adapter axis (Ca), and a central plane (Pc) orthogonal to the central adapter axis (Ca), the adapter (20) comprising:
a rear adapter end section (24);
a forward adapter end section (30) located forward of the rear adapter end section (24) and a peripheral adapter surface (70) connecting the forward adapter end section (30) and the rear adapter end section (24);
the forward adapter end section (30) including an adapter clamping portion (34), the adapter clamping portion (34) comprising an adapter clamping receptacle (38), the adapter clamping receptacle (38) defining:
a first flange bore (42) opening out to the peripheral adapter surface (70);
a second flange bore (44) opening out to the peripheral adapter surface (70); and
an actuator bore (66) extending into the adapter clamping receptacle (38);
and
a clamping mechanism (80) comprising:
an actuator (82) defining an actuating axis (A) having opposite first and second axial directions (D1, D2) extending parallel to the actuating axis (A), the actuator (82) being aligned with the actuator bore (66) and being at least partially located in the adapter clamping receptacle (38);
a central wedge (90) connected to the actuator (82);
a first flange (100) slidingly connected to the central wedge (90) and configured to project through the first flange bore (42); and
a second flange (102) opposite the first flange (100) about the actuating axis (A), the second flange (102) slidingly connected to the central wedge (90) and configured to project through the second flange bore (44);
each of the first and second flanges (100, 102) comprising:
a forward facing flange surface (106); and
a rearward facing flange surface (110), the rearward facing flange surface (110) comprising a rear slanted flange portion (112), the rear slanted flange portion (112) extending forwardly in the outward radial direction (Ro), the rear slanted flange portion (112) elongated in a direction along the central plane (Pc).

2. The adapter (20) according to claim 1, wherein the rear slanted flange portion (112) is cone shaped.

3. The adapter (20) according to claim 1, wherein each of the first and second flanges (100, 102) comprise a wedge connector portion (116) located adjacent to the central wedge (90), the wedge connector portion (116) connecting the forward and rearward facing flange surfaces (106, 110), the wedge connector portion (116) of the first flange (100) slants towards the actuating axis (A) in the first axial direction (D1) and the wedge connector portion (116) of the second flange (102) slants towards the actuating axis (A) in the first axial direction (D1).

4. The adapter (20) according to claim 3, wherein a wedge connector angle wca, defined between the actuating axis (A) and the wedge connector portion (116) of one of the first and second flanges (100, 102), fulfils the following condition: 5°≤wca≤25°.

5. The adapter (20) according to claim 3, wherein each of the first and second flanges (100, 102) comprise, at the wedge connector portion (116), a flange dovetail formation (118), the central wedge (90) comprises two wedge dovetail formations (98) engaging with the flange dovetail formations (118); each of the flange dovetail formations (118) in sliding engagement with one of the two wedge dovetail formations (98) in a direction along the actuating axis (A).

6. The adapter (20) according to claim 1, wherein the actuator (82) has an active position in which the first and second flanges (100, 102) project radially from the first and second flange bores (42, 44), respectively, wherein the actuator (82) has an inactive position in which the first and second flanges (100, 102) do not project radially from the first and second flange bores (42, 44), respectively.

7. The adapter (20) according to claim 6, wherein each of the first and second flanges (100, 102) further comprises an outer flange surface (114) facing away from the actuating axis (A), wherein in the inactive position, the outer flange surface (114) of each of the first and second flanges (100, 102) is level with the peripheral adapter surface (70) adjacent to the respective one of the first and second flange bores (42, 44).

8. The adapter (20) according to claim 1, wherein a rear slanted flange angle rsa, defined between the central plane (Pc) and the rear slanted flange portion (112), fulfils the following condition: 3°≤rsa≤20°.

9. The adapter (20) according to claim 1, wherein the clamping mechanism (80) further comprises an actuator captive mechanism (84) securing the actuator (82) in the adapter (20).

10. The adapter (20) according to claim 1, wherein the rearward facing flange surface (110) is planar.

11. The adapter (20) according to claim 1, wherein the first and second flanges (100, 102) are identical.

12. The adapter (20) according to claim 1, wherein the central wedge (90) comprises:
a first wedge surface (91);
a second wedge surface (92) located farther in the second axial direction (D2) than the first wedge surface (91);
a forward wedge surface (93) connecting the first and second wedge surfaces (91, 92);
a rearward wedge surface (94) located rearwardly of the forward wedge surface (93) and connecting the first and second wedge surfaces (91, 92);
an actuator wedge section (95) extending between the first and second wedge surfaces (91, 92) and engaged to the actuator (82);
a first flange connector portion (96) slidingly connected to the first flange (100), the first flange connector portion (96) extending between the first and second wedge surfaces (91, 92); and
a second flange connector portion (97) slidingly connected to the second flange (102), the second flange connector portion (97) extending between the first and second wedge surfaces (91, 92).

13. The adapter (20) according to claim 12, wherein the first flange connector portion (96) slants towards the actuating axis (A) in the first axial direction (D1) and the second flange connector portion (97) slants towards the actuating axis (A) in the first axial direction (D1).

14. The adapter (20) according to claim 13, wherein a flange connector angle fca, defined between the first and second flange connector portions (96, 97), fulfils the following condition: 10°≤fca≤50°.

15. The adapter (20) according to claim 14, wherein the wedge and flange connector angles wca, fca fulfil the following condition: fca=2*wca.

16. The adapter (20) according to claim 14, wherein each of the first and second flanges (100, 102) comprises a wedge dovetail formation (98).

17. A cutting tool (1) comprising
an adapter (20) according to claim 1; and
a cutting head (120) attached to the adapter (20), the cutting head (120) defining a central head axis (Ch) coinciding with the central adapter axis (Ca) of the adapter (20) and having forward and rearward head directions (Fh, Rh) extending parallel to the central head axis (Ch).

18. The cutting tool (1) according to claim 17, wherein the cutting head (120) comprises:
a forward head end section (122);
a rearward head end section (124) located rearward of the forward head end section (122) and a peripheral head surface (150) connecting the forward head end section (122) and the rearward head end section (124);
the reward head end section (124) comprising a head clamping portion (126), the head clamping portion (126) comprising:
a receptacle wall (132) comprising a forward facing head clamping surface (134) and a rearward facing head abutment surface (136), the receptacle wall (132) defining:
a head clamping receptacle (130) recessed into the head clamping portion (126); and
an actuator access bore (148) opening out to the peripheral head surface (150) and to the head clamping receptacle (130);
the peripheral head surface (150) comprising an integral cutting element or defining a cutting insert pocket (152) configured to receive a cutting element;
wherein in an active position of the actuator (82) of the adapter (20), the rear slanted flange portion (112) abuts the forward facing head clamping surface (134).

19. A cutting head (120) defining a central head axis (Ch) defining forward and rearward head directions (Fh, Rh), the cutting head (120) comprising:
a forward head end section (122);
a rearward head end section (124) located rearward of the forward head end section (122) and a peripheral head surface (150) connecting the forward head end section (122) and the rearward head end section;
the rearward head end section (124) including a head clamping portion (126), the head clamping portion (126) comprising a receptacle wall (132), the receptacle wall (132) including a forward facing head clamping surface (134) and a rearward facing head abutment surface (136), the head clamping surface (134) extending in a direction away from the central head axis (Ch) and in the forward head direction (Fh), the receptacle wall (132) defining:
a head clamping receptacle (130) recessed into the head clamping portion (126); and
an actuator access bore (148) opening out to the peripheral head surface (150)) and to the head clamping receptacle (130);
the peripheral head surface (150) including an integral cutting element or defining a cutting insert pocket (152) configured to receive a cutting element.

20. The cutting head (120) according to claim 19, wherein the head clamping surface (134) is elongated in a direction about the central head axis (Ch).

21. The cutting head (120) according to claim 20, wherein the head clamping surface (134) encircles the central head axis (Ch).

22. The cutting head (120) according to claim 19, wherein the head clamping surface (134) is cone shaped.

23. The cutting head (120) according to claim 19, wherein a head clamping angle hca, defined between the head clamping surface (134) and a head plane (Ph), the head plane (Ph) being perpendicular to the central head axis (Ch), fulfils the following condition: 5°≤hca≤22°.

24. The cutting head (120) according to claim 19, wherein the head abutment surface (136) comprises two rear abutting portions (138) and two relief portions (140) located forwardly of the two rear abutting portions (138), each of the two relief portions (140) being located between the two rear abutting portions (138).

25. A cutting tool (1) comprising:
an adapter (20); and
the cutting head (120) according to claim 19.

26. The cutting tool (1) according to claim 25, wherein the adapter (20) has a central adapter axis (Ca) defining an outward radial direction (Ro) extending away from the central adapter axis (Ca), opposing forward and rearward adapter directions (Fa, Ra) extending parallel to the central adapter axis (Ca), and a central plane (Pc) orthogonal to the central adapter axis (Ca), the adapter (20) comprising:
a rear adapter end section (24);
a forward adapter end section (30) located forward of the rear adapter end section (24) and a peripheral adapter surface (70) connecting the forward adapter end section (30) and the rear adapter end section (24);
the forward adapter end section (30) including an adapter clamping portion (34), the adapter clamping portion (34) comprising an adapter clamping receptacle (38), the adapter clamping receptacle (38) defining:
a first flange bore (42) opening out to the peripheral adapter surface (70);
a second flange bore (44) opening out to the peripheral adapter surface (70); and
an actuator bore (66) extending into the adapter clamping receptacle (38);
and
a clamping mechanism (80) comprising:
an actuator (82) defining an actuating axis (A) having opposite first and second axial directions (D1, D2) extending parallel to the actuating axis (A), the actuator (82) being aligned with the actuator bore (66) and being at least partially located in the adapter clamping receptacle (38);
a central wedge (90) connected to the actuator (82);
a first flange (100) slidingly connected to the central wedge (90) and configured to project through the first flange bore (42); and
a second flange (102) opposite the first flange (100) about the actuating axis (A), the second flange (102) slidingly connected to the central wedge (90) and configured to project through the second flange bore (44);
each of the first and second flanges (100, 102) comprising:
a forward facing flange surface (106); and
a rearward facing flange surface (110), the rearward facing flange surface (110) comprising a rear slanted flange portion (112), the rear slanted flange portion (112) extending forwardly in the outward radial direction (Ro), the rear slanted flange portion (112) elongated in a direction along the central plane (Pc).
